(19) United States
(12) Patent Application Publication
(10) Pub. No.: US 2014/0232229 A1
(43) Pub. Date: Aug. 21, 2014

(54) Permanent Magnet Work Generating Motor

(71) Applicant: Ronald Arthur Esmann, Jr., West Palm Beach, FL (US)

(72) Inventor: Ronald Arthur Esmann, Jr., West Palm Beach, FL (US)

(21) Appl. No.: 13/772,952

(22) Filed: Feb. 21, 2013

(51) Int. Cl. H02K 1/06

(52) U.S. Cl. CPC H02K 1/06; Y10S 74/09; H02K 53/00
USPC 310/152; 74/DIG. 9

(57) ABSTRACT

The device disclosed in this patent is a work generating device composed of magnetically transparent materials and permanent magnets, assembled to make a base, a rotor and a stator. The rotor is comprised of permanent magnet assemblies placed in a magnetically transparent material. The stator is an arrangement of permanent magnets, on one or more sides, adjacent to the linear potion of and parallel to the direction of travel of the rotor. The interaction of the rotor magnetic zone with the stator magnetic zone drives the rotor.

### CROSS-REFERENCE TO RELATED APPLICATION

U.S. Patent Documents

| | | |
|---|---|---|
| 4,151,431 | April 1979 | Johnson |
| 4,877,983 | Oct. 31, 1989 | Johnson |
| 5,402,021 | Mar. 28, 1995 | Johnson |
| 61/384,253 | Sep. 18, 2010 | Esmann |

### STATEMENT REGARDING FEDERALLY SPONSORED RESEARCH OR DEVELOPMENT

Not applicable

### REF. TO SEQUENCE LISTING, A TABLE, OR A COMPUTER PROGRAM LISTING CD

APPENDIX

Not applicable

### BACKGROUND OF THE INVENTION

Let me begin with the statement that this invention is neither a perpetual motion nor a fuel-less machine. The fuel is the magnetic fields of the permanent magnets and permanent magnets loose strength over time.

This invention relates in general to the use of permanent magnets to generate work, by harnessing linear propelling forces. The linear forces are converted to rotational forces and can be used for numerous purposes.

The ability to generate driving forces by permanent magnets has already been accomplished by Howard Johnson in his many builds and in his U.S. Pat. Nos. 4,877,983 and 5,402,021.

Howard Johnson's work, towards a usable motor, observed in the videos from “Energy from the Vacuum” appeared to be circular. The stator magnet assemblies were mounted in a circle around the rotor. The rotors observed were mounted on wheels or beams with a central shaft with the rotor magnet assemblies mounted on the circumference of the wheels or ends of the beams, their intended movement being circular. In Howard Johnson's U.S. Pat. No. 4,151,431, the rotor and stator magnet assemblies were circular and the spacing was discontinuous. Also, in U.S. Pat. Nos. 4,877,983 and 5,402,021, Howard Johnson used the more powerful magnetic material for the primary or lead magnets of the ‘gate’ or stator and a less powerful magnetic material for the ‘shade’ magnet of the ‘gate’. The magnets that Howard Johnson used are of three types, vinyl, ceramic, with neodymium complementing the other two. In my provisional patent 61/384,253 I was also attempting to convert my successful linear experiments to a circular form. Like Johnson, I was unsuccessful in the linear to circular translation.

In accordance with the present invention, rotor magnets, placed in the links of a chainlike device or on a belt, are guided along a linear path through a magnetic zone limited on one or more sides of the path by an arrangement of magnetic pole surfaces of one or both polarities on the stator magnets.
“Discovering Magnetism” 1970 by Howard Johnson reprinted as “The Secret World of Magnets” in 2006
“Energy from the Vacuum—Part 04” by Energetic Productions LLC 2008

### BRIEF SUMMARY OF THE INVENTION

The claimed invention uses identical polarity, magnetic zones to cause a rotor to turn a shaft. The rotor is flexible (a chain-like or belt-like device) which enables the rotor to be linear through the part of its movement where the rotor interacts with the stator. Also, the rotor magnets are continuous, which allows the rotor magnetic zone to be continuous and parallel throughout the linear portion. The flexible nature and continuous single poled magnetic zone of the rotor, correct the issues of a circular rotor with magnets spaced apart on the circumference. Through experimentation, I found that equal strength neodymium magnets in the actively used magnetic zone of the stator worked the best. All of the parts in close proximity to the magnetic zones would be made of materials that do not affect the magnetic zones. Some of the materials that could be used would be plastic, wood, glass, ceramic, non-magnetic metals like titanium, etc.

### BRIEF DESCRIPTION OF THE SEVERAL VIEWS OF THE DRAWING

FIG. 1 is a top view showing the chain embodiment of the invention.

FIG. 2 is a side elevation view showing the chain embodiment of the rotor, the placement of the stator and two double sprockets of the invention.

FIG. 3 is a top view showing the chain embodiment of the invention with some of the support materials removed for clarity.

FIG. 4 is a side elevation view showing the chain embodiment of the rotor, the placement of the stator and two double sprockets of the invention with some of the support materials removed for clarity.

FIG. 5 is a partial, side elevation view of the invention, showing one double sprocket and a part of the chain embodiment of the rotor.

FIG. 6 is several views showing one double sprocket and a section of the chain embodiment of the rotor.

FIG. 7 is several views showing a single link of the chain embodiment of the rotor and the roller or pin that holds the links together.

FIG. 7a is the top and elevation views showing three links of the chain embodiment rotor linked together.

FIG. 8 is a view of the magnets assemblies without the support structure, showing the function of the magnetic fields. Also, several rotor magnets shown in isometric view and a isometric view of stator magnets 20, 21, 30.

FIG. 9 is a partial, top view of the chain embodiment rotor and the structure of the stator.

FIG. 10 is a partial, top view showing another embodiment of the invention using a different arraignment of rotor magnets.

FIG. 11 is a partial, top view showing another embodiment of the invention using a different shaped rotor magnet.

FIG. 12 is a partial, side view showing an embodiment of the invention with the stator on a single side. The rotor assemblies are the same as FIG. 10 with only a single row.

FIG. 12a is a top view showing the rotor embodiment of FIG. 12.

FIG. 13 is a partial, side view showing another embodiment of the invention with the stator on a single side. The rotor assemblies are the same as FIG. 9 with only a single row.

FIG. 13a is a top view showing the rotor embodiment of FIG. 13.

FIG. 14 is an isometric view of the top, front and side of a link of the chain-like rotor.

FIG. 14a is an isometric view of the top, front and side of two links of the chain-like rotor attached together with a roller or pin.

FIG. 15 is an isometric view of the bottom, front and side of a link of the chain-like rotor.

FIG. 15a is an isometric view of the bottom, front and side of two links of the chain-like rotor attached together with a roller or pin.

FIG. 16 is a partial, side view showing another embodiment of the invention with the stator on a single side and the rail replacing the smaller double sprocket support. The rotor assemblies are the same as FIG. 12 with only a single row.

FIG. 16a is a top view showing the rotor embodiment of FIG. 16.

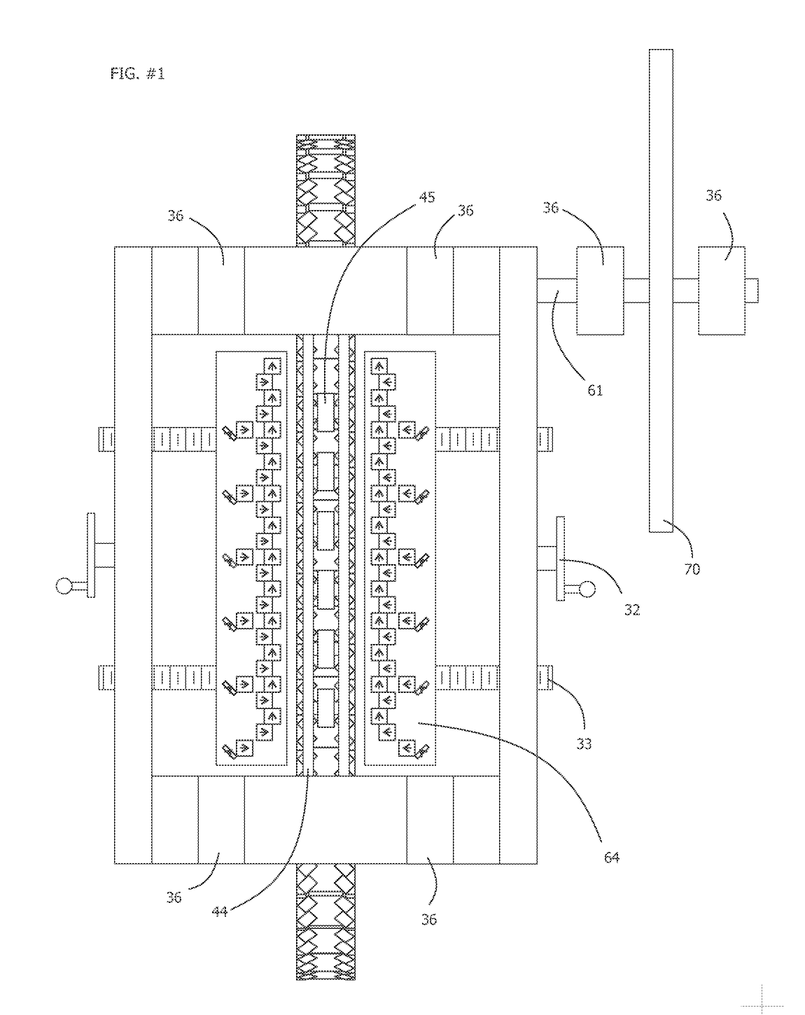

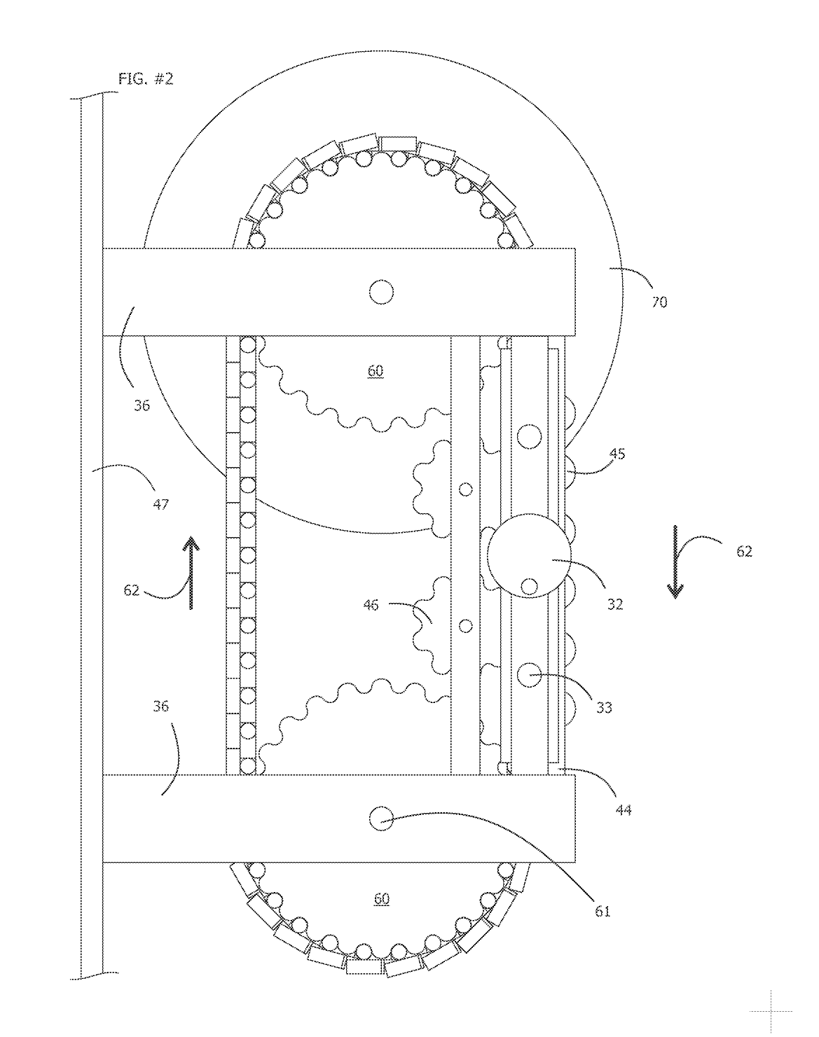

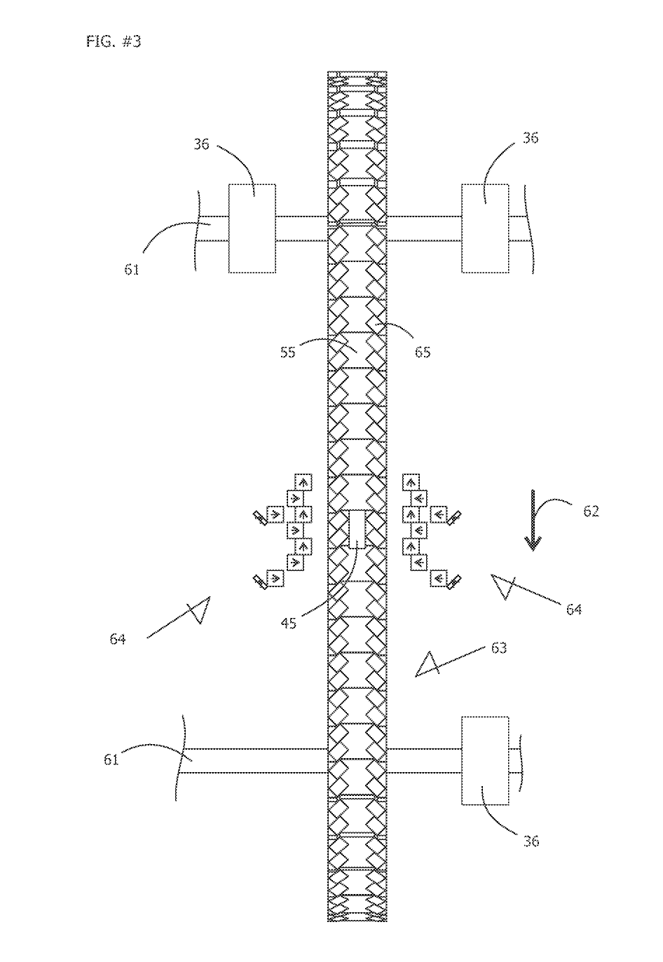

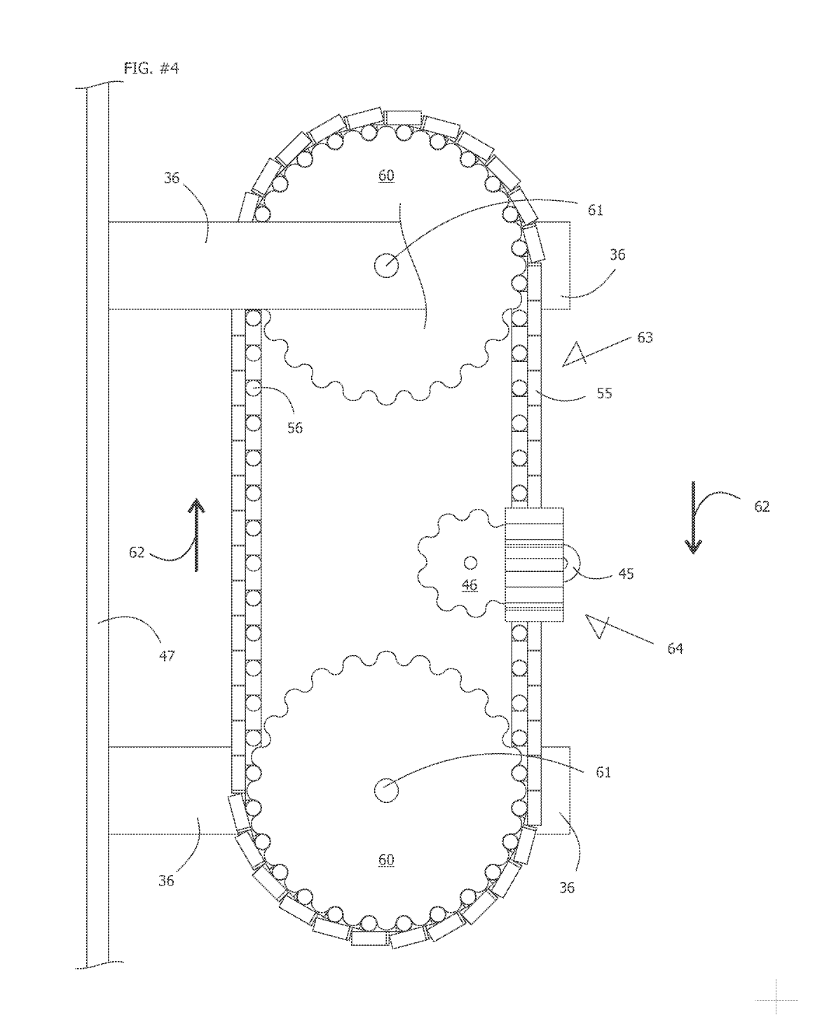

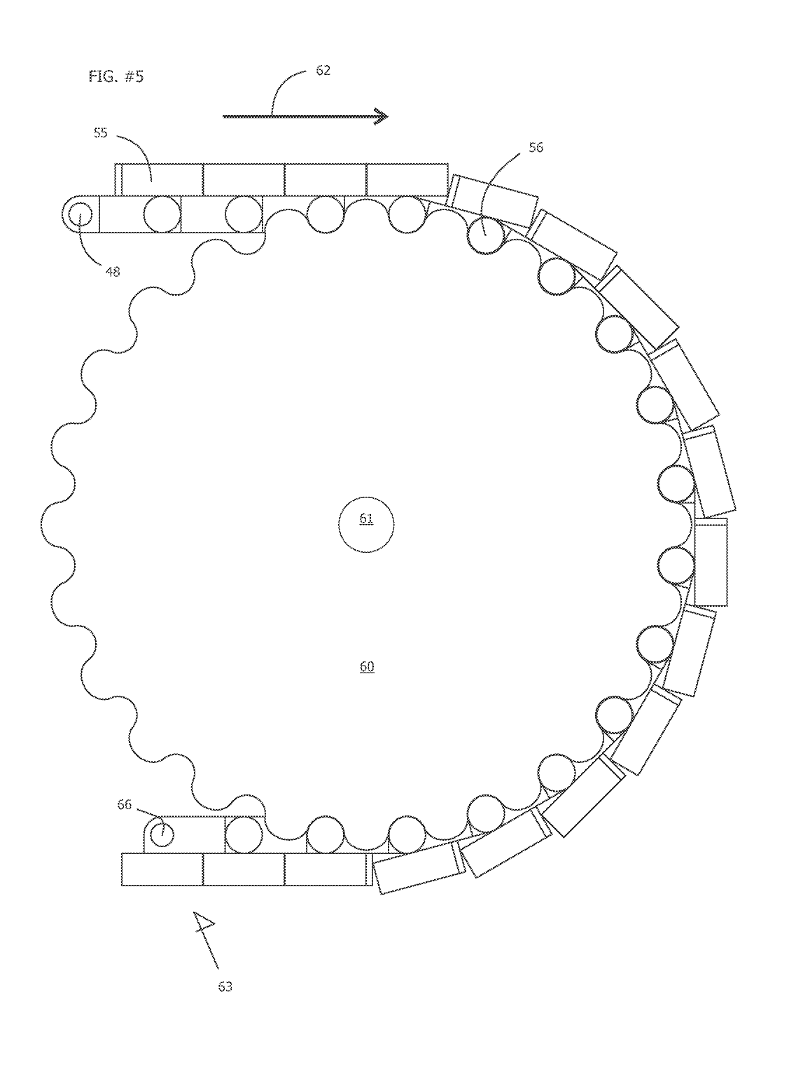

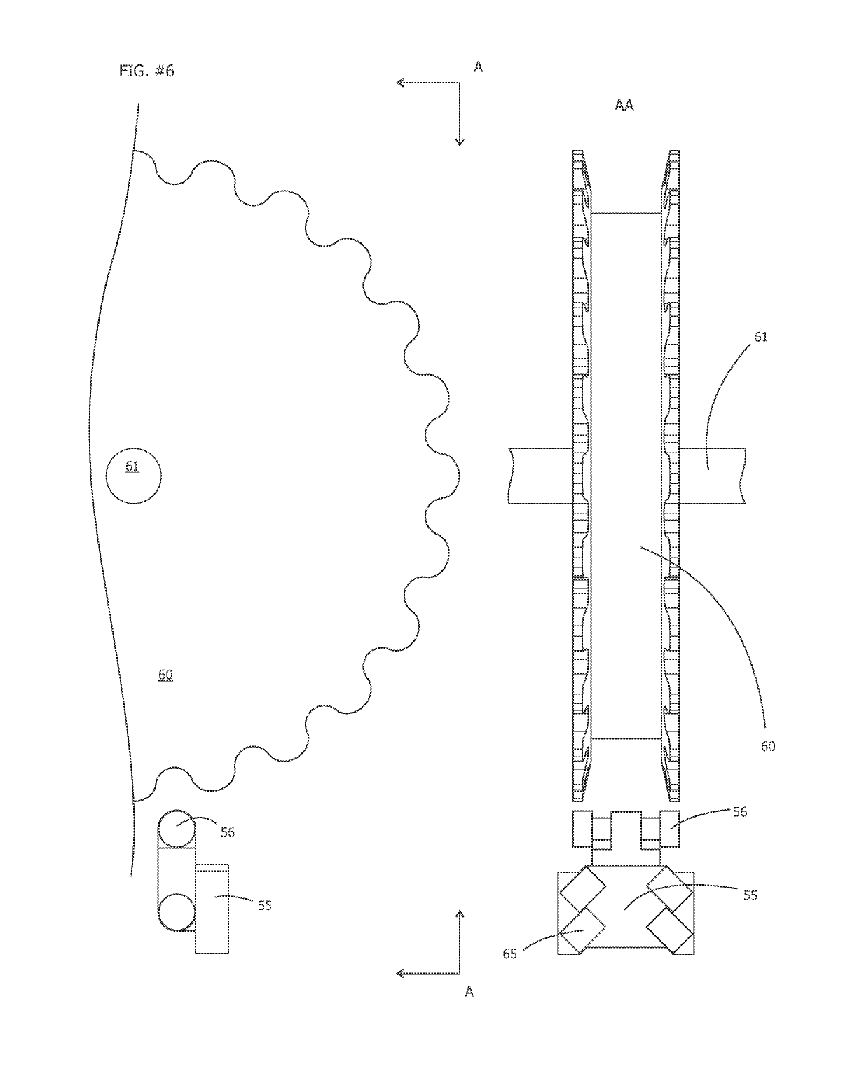

### DETAILED DESCRIPTION OF THE INVENTION

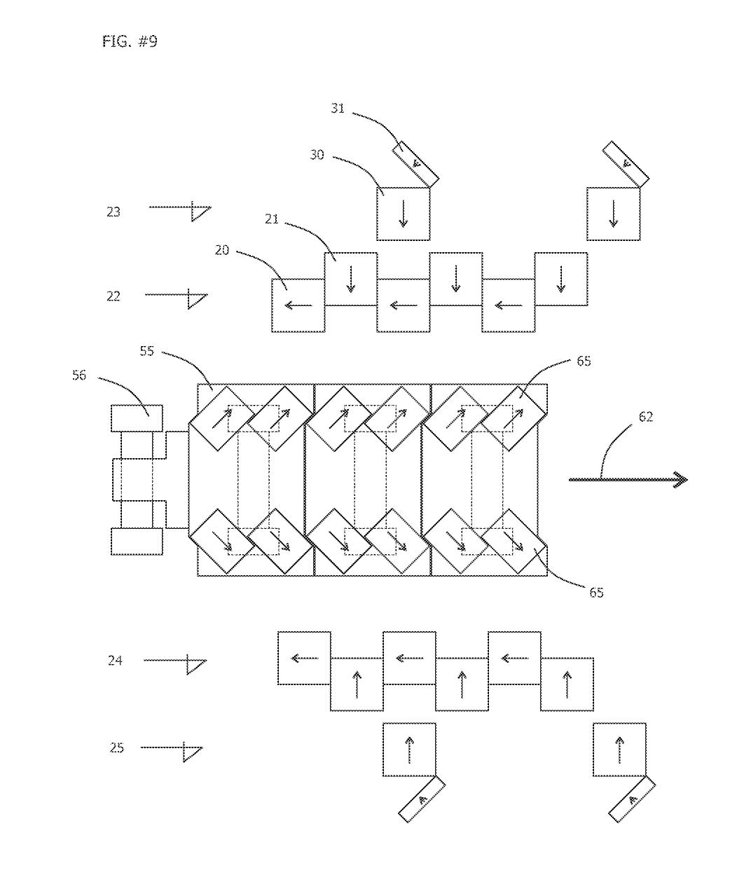

Referring now to the drawings in detail: the drawings illustrate the invention in which magnetically transparent links 55 are attached together to make a chain, rotor 63. Affixed to the links 55 are magnets 65 attached evenly and continuously on one or more sides. The magnets 65 are generally rectangular in shape from pole the pole. Also, the magnets 65 can be square from non-pole to non-pole or rectangular from the bottom side to the top of link 55. The links 55 have magnets 65 arraigned so that one pole (the actively used pole) is exposed and the other pole is blocked by the exposed pole of the next magnet 65. This creates a single poled magnetic zone flowing in one direction. The stator 64 has an arraignment of magnets fixed to the base 47 in such way that the stator 64 can be moved towards and away from the rotor 63 with handle 32. The stator 64's magnets 20, 21 and 30 are generally rectangular in shape from non-pole to non-pole from the top to bottom and square on the other two non-pole sides on the top and bottom. Handle 32 is used to adjust the worm screws 33 and can be replaced with a stepper motor for remote control. The arraignment of the magnets of the stator 64 creates a single poled magnetic zone, the same pole as the rotor 63, flowing in one direction opposite from the rotor 63's magnetic zone. FIG. 9 shows an expanded view of three links 55 of the rotor 63 and a portion of the stator 64. The stator 64 can be as long as the two linear portions of the rotor 63. Both linear parts of the rotor 63 can have a stator 64. With the proper support, rotor 63 can be as long as one would want. The action of the two like poled magnetic zones flowing in opposite directions with the stator 64 affixed to the base 47, causes the mobile rotor 63 to move in the intended direction of travel 62. The double sprockets 60 are fused to the shafts 61. The action of the rotor 63 causes the double sprockets 60 and shafts 61 to rotate. The shafts 61 are attached to support beams 36 through bearings to the base 47. The stator 64 and rotor 63 magnetic fields are compressing each other. This action in close proximity appears to increase the force of the magnetic zones, similar to the effect of water being forced through smaller diameter pipes. The multiple magnetic fields between the rotor 63 and stator 64 are stronger than the rotor magnet 65's resistance to enter and exit the stator 64's magnetic zone.

FIG's 2 and 4, side elevation views of FIG's 1 and 3, shows the direction of travel 62 of the rotor 63. The movement of the rotor 63 causes the two double sprockets 60 to rotate the two shafts 61. The shafts 61 are attached to the base 47, but are free to rotate. The chain rotor 63 is flexible being made of several links 55 attached front to back by a pin or roller 56. Bearings 45 and small double sprocket 46, hold the rotor 63 level and in the stator 64's magnetic zone. Bearings 45 are held in place by supports 44.

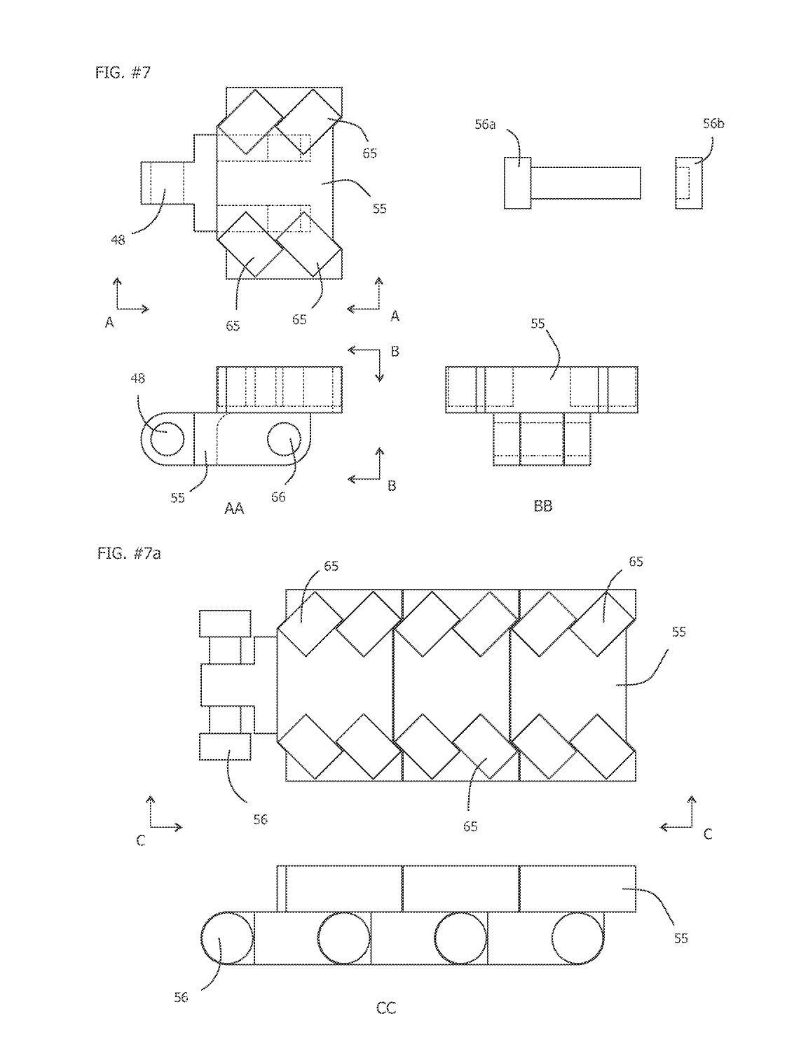

FIG. 7 shows several views of one embodiment of an individual link 55 of the rotor 63. The magnets 65 are angled at approximately 45 degrees towards the stator 64. If the starting magnet 20 of the stator 64 uses the north magnetic field then each magnet 65 will have the north pole angled out towards the stator 64. The rotor chain 63 would be assembled by placing the rear roller hole 48 of one link 55 in-between the two front roller holes 66 of another link 55. Then a pin part 56a will be placed through the roller holes 48 and 66 at the same time locking the two links 55 together. Pin part 56b would be attached to the smaller end of pin part 56a in a way that allows the completed pin 56 to rotate freely in roller holes 48 and 66. When the rotor 63 is in its linear format, all of the rotor magnets 65 stack together. The unused poles are covered by the active poles at this time. This creates a single poled, continuous zone of magnetic fields radiating in the same direction. When the rotor 63 has two rows of magnets, there should be distance between the two rows, the amount to be determined by the strength of the magnets.

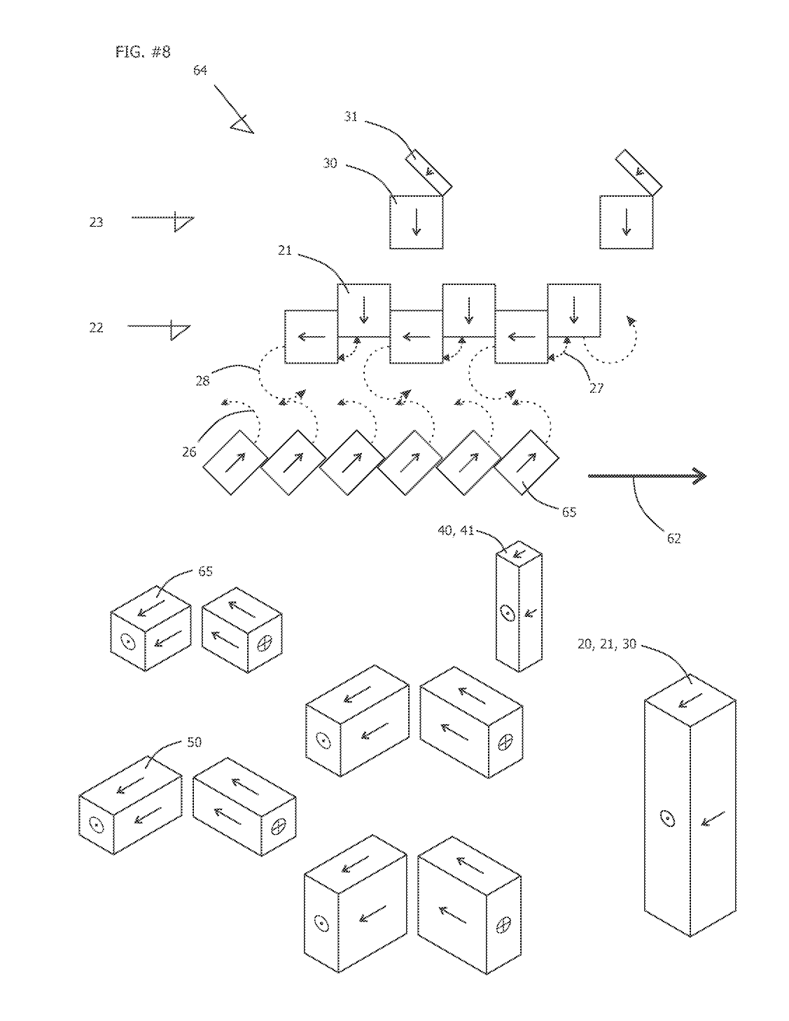

FIG. 8 is a top view showing the functions of a single sided version of the stator 64 and the rotor magnets 65. The single sided version of stator 64 is comprised of two rows 22 and 23. Stator row 22 creates the active magnetic zone that will interact with the active magnetic zone of the rotor magnets 65. Stator magnet 20 (generally rectangular in shape) is shown with the north pole facing in the opposite of the intended direction of travel 62 of the rotor magnets 65. In this configuration, the north pole would be the active magnetic field. The active magnetic field 28 is created by stator magnets 20. Stator magnet 21, the same size and strength as magnet 20, is placed on the inactive/unused pole of magnet 20 with the active pole of magnet 21 facing the path of rotor magnets 65. The active magnetic fields of magnets 21 counteracts the inactive/unused magnetic fields of the magnets 20, this action being represented by magnetic field 27 of each assembly 20,21. The interaction of the magnets 20 and 21 create the active magnetic field zone in proximity to the rotor magnets 65 zone created by the magnetic fields 26. The rotor magnets 65 are stacked so that the magnetic fields 26 are exposed to the stator 64 and the inactive pole is covered by the active pole of the neighbor magnet 65. This creates an active, single poled magnetic field zone by the rotor 63. The two zones of like poled magnetic fields radiating in opposite directions, cause the rotor magnets 65, and thereby the mobile rotor 63, to move in the intended direction of travel 62. The double sided embodiment of the invention will have a total of four rows for the stator 64, rows 22, 23, 24, and 25. Row 24 of the stator 64 is a mirror image of row 22, parallel to the direction of travel 62, on the opposite side of the rotor 63. Row 25 of the stator 64 is a mirror image of row 23, parallel to the direction of travel 62, on the opposite side of the rotor 63.

An inactive magnetic zone is created on the side of stator row 22 that faces away from the rotor magnets 65. Stator row 23 (and 25 when the rotor has rows of magnets 65), comprised of magnets 30 and 31, reduces the influence of the inactive/unused magnetic zone of the stator row 22 on the rotor 63's magnets as the rotor 63's magnets exit the stator 64s magnetic field zone. Magnet 30 is the same strength and size as magnets 20 and 21. Magnets 31 are the same height and width as magnets 30, but as shown in the drawings are a different thickness. Magnets 30 are placed with their active pole facing the magnets 65 on the opposite side of the stator row 22 and between the magnets 21. The active magnetic fields of magnets 30 absorb some of the inactive magnetic zone created by the stator row 22. Magnet's 31 active poles are placed on the inactive poles of magnets 30 and angled at approximately 45 degrees away from the magnets 65 with the inactive poles towards the intended direction of travel 62. Magnet assemblies 30, 31 are repeated one for every two or three magnet assemblies 20, 21 starting at the end of row 22 where the magnets 65 are exiting the stator 64's magnetic zone. The distance between rows 22 and 23 and rows 24 and 25, will be determined by the strength of the magnets of the stator 64.

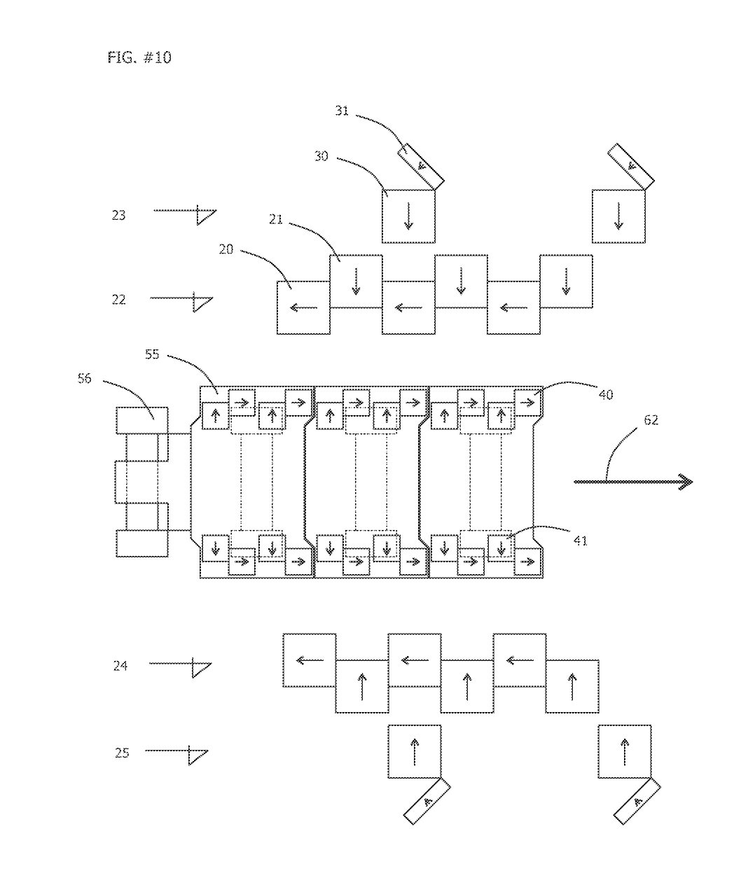

Another embodiment of the invention is shown in FIG. 10. In this embodiment, the rotor 63 is comprised of a different magnet assembly. The stator row 22 assembly is used in the rotor 63 to create the active magnetic zone. Rotor magnets 40 and 41 (generally rectangular in shape) are smaller less powerful magnets than the stator magnets 20, 21 and 30. Rotor magnets 40 are placed with the active poles facing the intended direction of travel 62. Rotor magnets 41 are placed on the inactive poles of magnets 40, with the active pole facing the stator 64's magnet assemblies. The rotor magnet assemblies 40, 41 are a continuous loop and evenly spaced so the inactive magnetic zone will stay on the inner part of the rotor 63. When the rotor 63 has two rows of magnet assemblies, there should be distance between the two rows, the amount to be determined by the strength of the magnets.

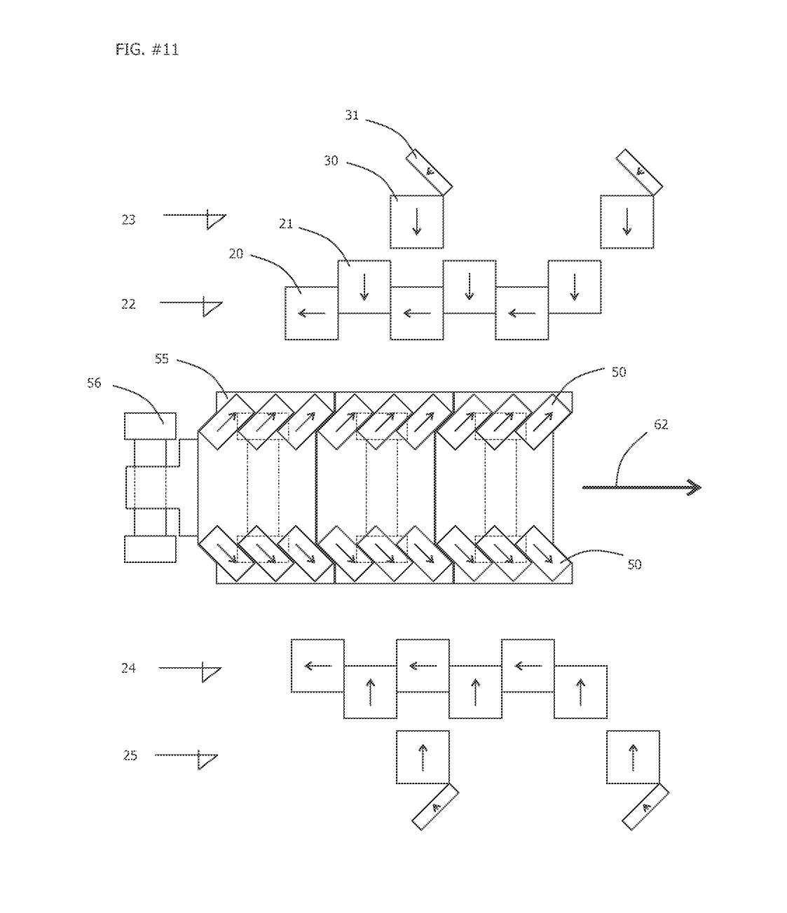

FIG. 11 is yet another embodiment of the invention with different shaped magnets for the rotor 63. In this embodiment, rotor magnets 50 are used. These magnets 50 are twice the thickness as the width and are generally rectangular in shape. This arraignment was also tested and shown to work.

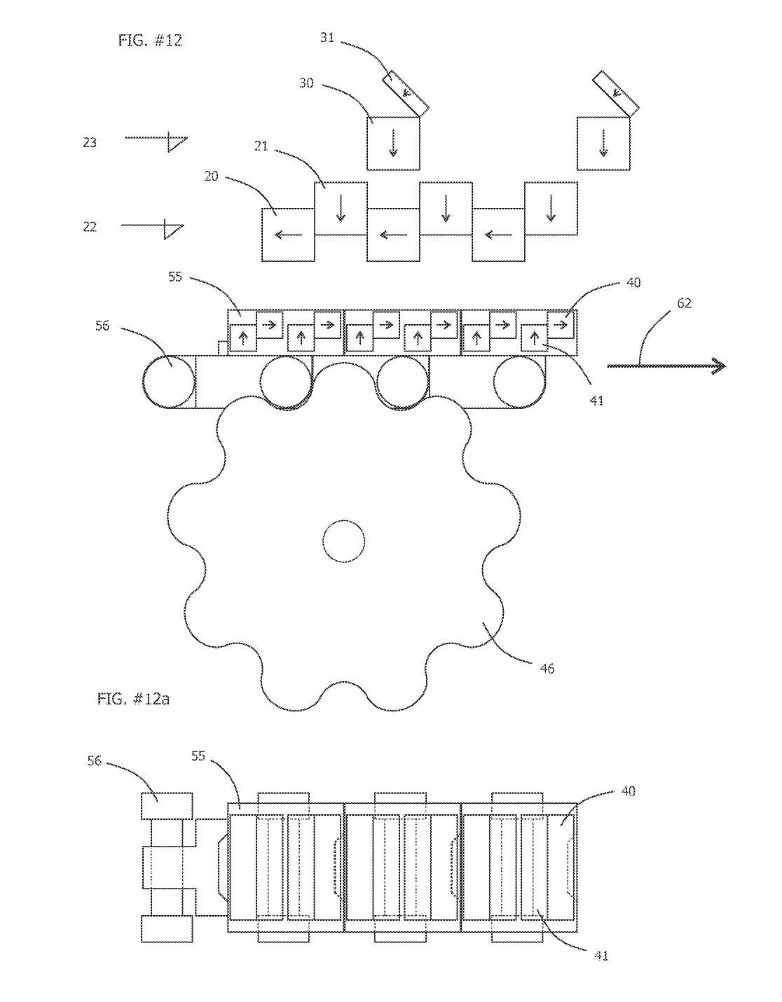

Yet another embodiment of the rotor 63 of the invention is shown in FIGS. 12 and 12a. In this embodiment, the rows 22 and 23 of the stator 64 are identical to the other embodiments. In this embodiment there is only a single row of magnet assemblies 40, 41 mounted parallel to the roller pins 56. Small double sprocket 46 would be placed on the opposite side of rotor 63 and adjacent to the stator 64. This will hold rotor 63 linear and in parallel proximity to the magnetic zone of stator 64.

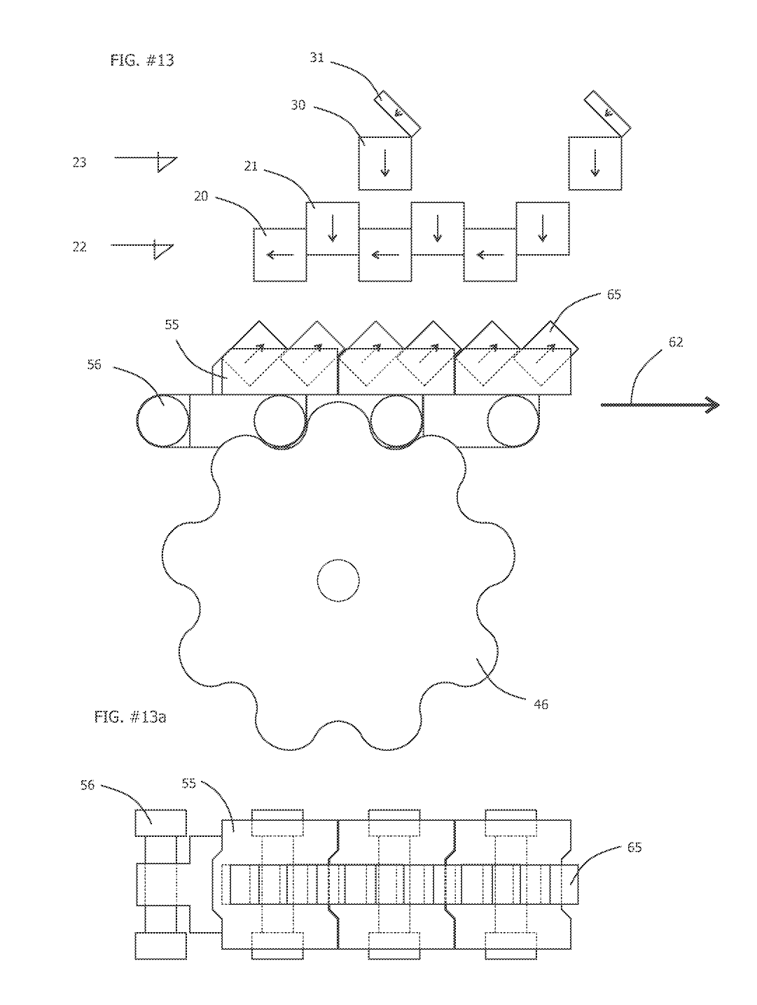

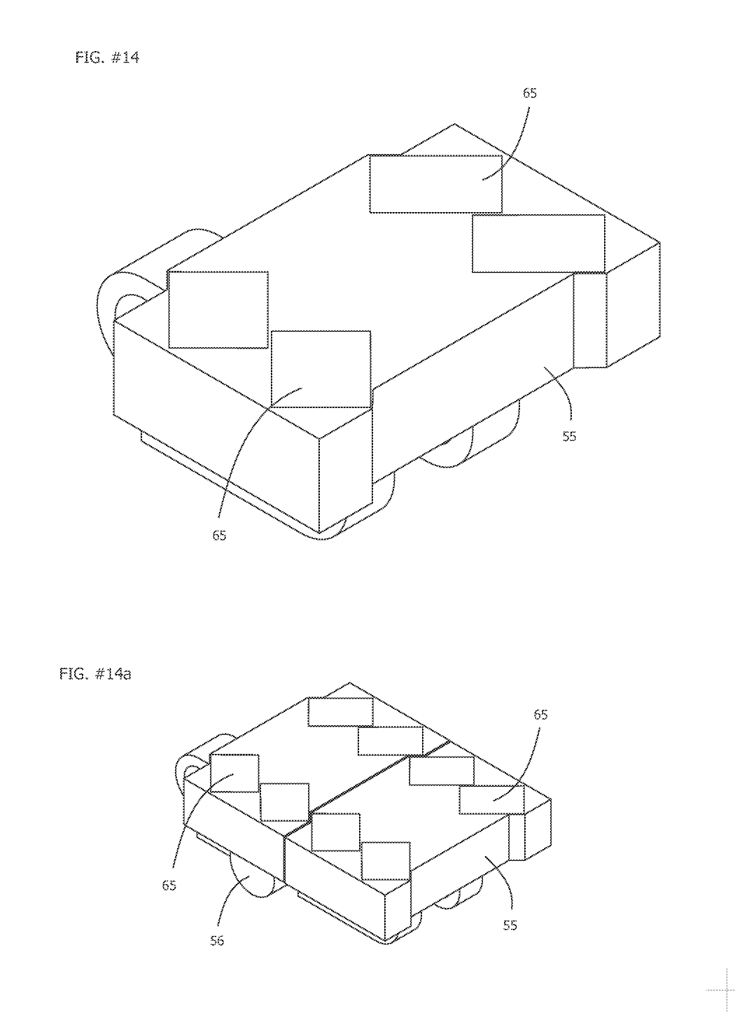

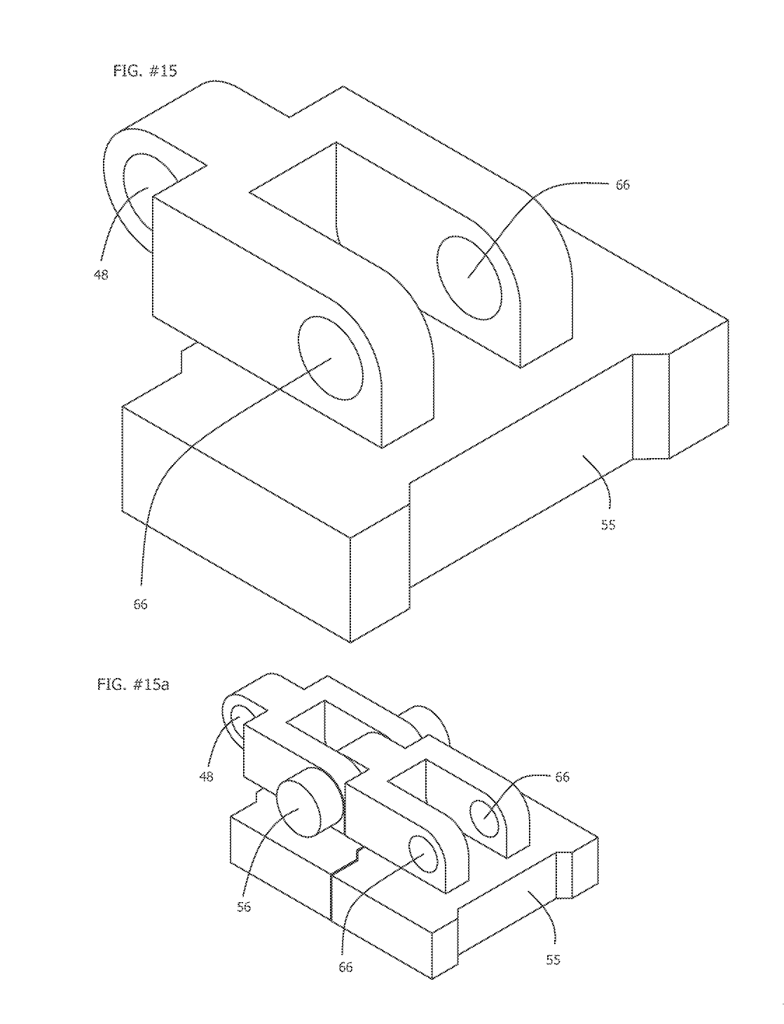

Another embodiment of the rotor 63 of the invention, in FIGS. 13, 13a, shows rows 22 and 23 of the stator 64 with a single sided rotor 63 using magnets 65. In this embodiment, magnets 65 function identically to one row of the rotor 63 magnets of FIGS. 9 and 11. Small double sprocket 46 would be placed on the opposite side of rotor 63 and adjacent to the stator 64. This will hold rotor 63 linear and in parallel proximity to the magnetic zone of stator 64.

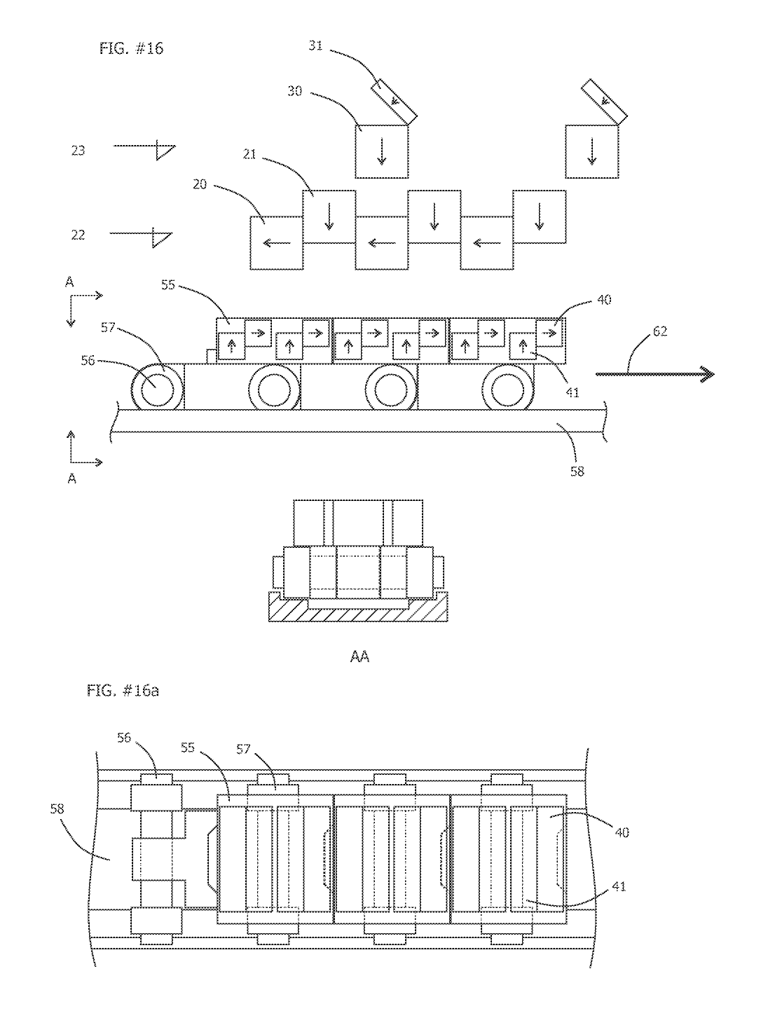

Another embodiment of the invention, illustrated in FIGS. 16 and 16a, would have bearings 57 on the roller pins 56. With this embodiment, the bearings 57 and rail 58 would replace the smaller double sprockets 46. With bearings 45 holding the rotor 63 in place from the top, bearings 57 would ride on the rail 58. The rotor 63 would be held level and perpendicular to the magnets of the stator 64. With the single side embodiment of the rotor 63, the interaction of the stator 64's magnetic zone and rotor 63's magnetic zone would hold the rotor 63 on the rail 58.

What is claimed is:

1. An apparatus for generating work, wherein the apparatus comprises:
A. a flexible rotor (Chain-like or Belt-like) that can rotate in a clockwise or counterclockwise direction and having magnets affixed to it evenly and closely spaced throughout;
B. a series of stator magnet assemblies located parallel to, but spaced apart from the linear portion of the rotor;
C. the stator magnet assemblies create a stationary magnetic field focused in one direction within the space contained by the stator magnet assembly and the rotor;
D. several stator magnet assembles are spaced along one or more side of the linear portion of the rotor, the space to be determined by the strength of the assemblies;
E. the rotor magnets are placed to cover or reduce the influence of the unused pole and arraigned so the active rotor magnetic field is focused in the opposite direction of the active stator magnetic field;
F. the stator's active magnetic field zone propel the rotor magnets, that are in the zone, with a force x;
G. the stator magnets attract the rotor magnets as they exit the magnetic field zone and repel the rotor magnets as they enter the magnetic field zone, with a force less than x;
H. the rotor magnets are spaced on the linear portion so that there are several rotor magnets being propelled through the stator magnetic zone at all times.

2. An apparatus as defined by claim 1 wherein a rotor or multiple rotors are attached to a direct drive or belt/chain driven assembly to harness the rotational work of the claimed invention to generate energy.

3. An apparatus as defined by claim 1 wherein a rotor or multiple rotors are attached to a direct drive or belt/chain driven assembly to harness the rotational work of the claimed invention to operate a fluid pump.

4. An apparatus as defined by claim 1 wherein a rotor or multiple rotors are attached to a direct drive or belt/chain driven assembly to harness the rotational work of the claimed invention to move objects (e.g. an assembly line belt, a vehicle, etc.).
